(19) United States
(12) Patent Application Publication
(10) Pub. No.: US 2002/0100606 A1
(43) Pub. Date: Aug. 1, 2002

(54) INSULATING, SIGNAL SUPPRESSING, CLAMPING FEEDTHROUGH

(76) Inventors: Mathew G. Rule, Carmel Valley, CA (US); Randolph W. McKernan, Graton, CA (US)

Correspondence Address: Mathew G. Rule, 20 Paso Del Rio, Carmel Valley, CA, 93924, US

(21) Appl. No.: 09/774,817

(22) Filed: Jan. 30, 2001

(51) Int. Cl. H01B 17/26

(52) U.S. Cl. 174/151

(57) ABSTRACT

Disclosed is a panel feedthrough that provides insulation, strain relief, and selective attenuation of electrical signals by ferromagnetic means. The feedthrough consists of an externally toothed sleeve that has a fixed restraining flange, a ratcheting cap and, optionally, an additional locking ring, both of which engage teeth on the sleeve. Panel clamping action occurs when a panel is pressed between the cap or locking ring and the restraining flange of the sleeve. Various combinations of ferrite toroids or beads may be added over the outside of the sleeve and held in place by the cap or locking ring. The clamping of wires, cables or other objects passing through the feedthrough is accomplished by inward deflecting, tapered tabs located at one end of the sleeve. These tabs are deflected into a clamping action by the cap bearing a tapered hole into which the tabs are forced. The cap is snapped over the tabbed end of the sleeve and held in place by internal teeth ratcheting with those teeth found on the outside of the sleeve. Rotation of the feedthrough is arrested and clamping action on the panel is enhanced by the optional use of an adhesive disk or layer between the panel and the sleeve's fixed restraining flange. This feedthrough may also be used as an inline filter by clamping it to a wire or cable using the same bead securing and wire clamping procedures outlined.

### TECHNICAL FIELD

This invention relates generally to surface feedthrough mechanisms. More particularly, this invention relates to an article that simultaneously insulates, secures and provides adaptable signal filtering to a wire, cable, tube or other elongated object being passed through an opening in a surface.

### BACKGROUND

In the process of manufacturing devices or systems that contain electrical or electronic components, it is often necessary to pass wires or cables from an enclosed area to another area within or outside the device. In current art, the common solution is to make a hole in the surface dividing the two enclosed areas, then either pass the wire or cable through the hole in the chassis directly or via some feedthrough device or group of devices. Note that this is also true of non-electronic devices or systems where it is necessary to pass tubing or any other elongated component through an opening in a surface.

In the case of electronic systems, in order to prevent insulation damage to the wire or cable caused by chafing of the chassis hole edges, an insulation protection scheme is typically used. This may be in the form of a well-known grommet approach, or may take the form of “heat-shrinkable” tubing placed onto the wire or cable prior to permanent connection of the wire or cable ends.

In order to stabilize the position of a wire, cable, tube or other elongated component passing through a chassis hole, a mechanical securing strain relief mechanism is normally used. Many forms of mechanical strain relief for wires and cables are known in the art.

When unwanted signals are potentially present in or near wiring in an electronic device, it is often necessary to prevent such signals from propagating via the wiring from one area of the device into another area. Passing wires or cables through the center of a ferrite toroid device provides a way to prevent certain signals present on one end of the wire or cable from passing beyond the toroid, thus filtering the signal from the other end of the wire or cable. Using toroids as a filtering mechanism typically requires the toroid to be secured to a specific position on the wire or cable. Another form of signal filtering is electronic voltage surge protection. Often it is desirable to prevent a transient over-voltage condition present on an electrical conductor from causing damage to the electronic components in a device. Surge arrestors are sometimes used in such a case. Many forms of surge arrestors are currently available, including those that encircle a wire (passing the wire through the surge protection device without interrupting the wire).

Currently, in order to address the three issues discussed above, when manufacturing a device that requires wires, cables or other elongated components to pass through openings in the chassis, circuit boards, bulkheads or other planar surfaces of the device, it is common to perform the following three processes separately for each wire or cable passed through a hole:

First, install a grommet or insulating mechanism to protect the wire or cable from chafing damage.

Second, install a strain relief or securing mechanism to prevent the wire or cable from moving undesirably.

Third, secure a signal filtering mechanism and/or surge protector into or proximate to the wire or cable (if required).

Each of the three processes named above often require a number of sub-steps in order to perform them. In the manufacturing industry, efficiencies are gained when more than one assembly task or process can be combined into a single process or action. In manufacturing cases where a group of assembly tasks are repetitive, each repetition where the group of tasks is performed as a combined action increases the efficiency of the manufacturing process. If the three processes named above were combined into a single process with fewer overall sub-steps, manufacturing efficiencies are gained.

### DESCRIPTION OF PRIOR ART

In the current state of the art, feedthrough devices are found primarily in the three major classes of filtering feedthroughs, insulating feedthroughs and grounding feedthroughs. Additionally, provision of signal suppression (filtering) for wires or cables not being passed through a panel is available in the current state of the art. Each of these categories of prior art is discussed separately in the sections below.

Filtering Feedthroughs

This class of electrical feedthroughs provides signal suppression for wires passing through an electrical panel or chassis. These primarily fit into the categories of capacitive, inductive or a combination of both types of filtering.

With capacitive feedthroughs, the signal suppression is accomplished by electrically connecting capacitive elements between the wire and electrical ground. Reference is made to U.S. Pat. No. 4,747,019 [May 24, 1988] where Ito creates a capacitive feedthrough utilizing a proprietary mounting frame. U.S. Pat. No. 5,896,267 [Apr. 20, 1997] discloses where Hittman provides for a substrate mounted capacitive filtering feedthrough.

These and other similar capacitive filtering feedthroughs have a number of inherent disadvantages, including those described in the following paragraphs.

Capacitive type feedthroughs require a connection to the current carrying conductor. This introduces an anomaly into the wire. Cutting and soldering of the wire is often required, which usually leaves exposed connections on either side of the panel through which the wire passes. Cutting and soldering of the wire is also a labor-intensive process, adding to production costs and times.

Capacitive type feedthroughs require an electrical ground for operation, and typically must be mounted on an electrically conductive panel or in proximity to an electrical ground source, depending on the specific type of the feedthrough. This adds potentially expensive requirements to the design of the device.

Capacitive feedthroughs have multiple failure modes. One failure mode is the case where the current carrying conductor is electrically shorted to ground due to a breakdown of the internal capacitor's dielectric material. This disadvantage is well recognized, since U.S. Pat. No. 4,148,003 [Apr. 3, 1979] by Colburn shows an attempt to overcome this problem by connecting groups of filter capacitors in series. Unfortunately, Colburn's solution adds cost and complexity to the manufacturing process. A second failure mode is that of cessation of the capacitive filtering action due to an internal failure of the capacitive components of the feedthrough. This failure mode is often not apparent, and protection may be lost without an indication.

Capacitive feedthroughs also have the disadvantage of being inherently single wire application devices. While arrays of capacitive feedthroughs may be manufactured into a multi-conductor cable connector, each filtered conductor of the cable must be passed through an individual capacitive feedthrough. This approach adds cost to the manufacturing process since the manufacturer must stock relatively expensive (and often custom) cable connectors. In addition, this approach requires an additional connector to be assembled onto the cable for mating with the feedthrough connector. Finally, this approach adds several potential points of failure in a circuit; the connection can mechanically fail and multiple devices, one for each wire in use, arithmetically increase the chance of failure modes.

An example of a feedthrough with inductive elements is seen in U.S. Pat. No. 4,737,745 [Apr. 12, 1988] whereby Doepker stipulates the additional use of ferrite cores. A similar design may be found in U.S. Pat. No. 4,267,529 [May 12, 1981] where Brun utilizes both capacitive and ferromagnetic elements for filtering action.

Disclosed in U.S. Pat. No. 5,546,058 [Aug. 13, 1996] by Azuma is a filtering type feedthrough that may use either a capacitive or ferrite element. This device has the same disadvantages that limit other filtering feedthroughs, except that it does not have a failure mode when a ferrite element alone is used.

Other devices for filtering may be used in a feedthrough in place of the capacitive and inductive elements delineated in the above art. U.S. Pat. No. 5,195,014 [Feb. 12, 1992] by Krantz uses zener diodes for transient protection. This has the inherent drawbacks of the other filtering feedthroughs, with the added limitation of a filtering action that is restricted to clamping over-voltage transients.

Filtering feedthroughs of any category typically provide little or no support, security or strain relief to the wire. Many filtering feedthroughs rely on soldered connections to physically support the wire passing through them, introducing additional mechanical stress onto the current carrying elements of both the feedthrough and the wire.

Most capacitive and inductive feedthroughs are designed for use in panel applications only, making them unusable for free-hanging wires or cables.

The capacitive or inductive values used for state of the art filtering feedthroughs are fixed, not allowing user manipulation of the filtering characteristics of an individual feedthrough.

Insulating Feedthroughs

In the current state of the art, insulating feedthroughs are available that provide various means to insulate and, in some cases, secure the wire(s) or other item(s) passing through the feedthrough.

U.S. Pat. No. 5,374,017 [May 7, 1992] by Martin, U.S. Pat. No. 4,535,196 [Nov. 4, 1982] by Milne, and U.S. Pat. No. 4,161,622 [Dec. 22, 1976] by Drayer provide examples of prior art of this type. Also relevant are U.S. Pat. No. 4,956,525 [Sep. 11, 1990] by Wilk, U.S. Pat. No. 5,594,202 [Jan. 14, 1997] by Tobias, and U.S. Pat. No. 5,211,695 [May 18, 1993] by Dowler. However, none of these insulated feedthrough devices provide any form of signal suppression or filtering.

U.S. Pat. No. 4,195,330 [Mar. 25, 1980] by Savage describes a specific example of an article that uses a flanged, hollow feedthrough and retaining ring to secure an object to a bulkhead or panel, providing insulation between chassis ground and the object passing through it. Savage shows a panel-mounting LED holder. However, Savage's article is specific to mounting and securing an LED. Its specific shape and features are not well suited for inclusion of ferrite toroids. Specifically, the article of Savage's LED holder does not provide any significant flexibility in the distance between the retaining ring and the bulkhead in its installed configuration. This lack of flexibility eliminates the possibility of including ferrite toroids into the installed article. Further, the article of Savage's LED holder includes features that are very specific to mounting LEDs, and that would be disadvantageous in other applications.

Ground Feedthroughs

Grounding feedthroughs generally attach onto a cable that contains an outer electrical shielding element, providing continuity to electrical ground for the shielding element of the cable. Grounding feedthroughs are typically used to conduct stray electrical energy from the cable's shielding element to electrical ground.

An example of a common application of this class of feedthrough is providing electrical continuity between chassis ground and the outer electrical shield of a coaxial cable where the cable passes through an opening in an electrically grounded conductive panel or chassis.

As represented by U.S. Pat. No. 4,700,155 [Oct. 13, 1987] by Sakamoto, these devices often require that the outer insulating jacket of the cable be cut, or that some other invasive procedure be followed during installation. This adds time and expense to the production process.

This class of feedthrough does not allow convenient addition of external filtering elements and lacks utility for wires and cables that do not have an outer electrical shield.

Wire Filters

A secondary but significant use of the present invention is to filter a cable or wire that is in free space (where the wire or cable not passing through a surface). Ferrite beads and split beads have become the elements of choice for this type of service, and are well known in the art.

U.S. Pat. No. 6,054,649 [Apr. 7, 1998] by Uchida shows beaded insulated wire. Clamp-on arrangements are found in U.S. Pat. No. 5,291,172 [Mar. 1, 1994] by Ido, U.S. Pat. No. 4,882,561 [Oct. 21, 1989] by Fujioka and U.S. Pat. No. 4,983,932 [Jan. 10, 1991] by Kitagawa and others. However none of these devices provides for user selection of multiple commercially available ferrite beads of differing properties. This disadvantage limits filtering flexibility, and potentially increases costs to the manufacturer who must stock a different part for each application that requires different filtering characteristics.

Ferrite toroids for multiple wire cables have also found an application with connectors that can potentially be used with cables that are not being passed through an opening in a surface. U.S. Pat. No. 4,960,392, [Sep. 2, 1990] by Dickie and U.S. Pat. No. 5,346,410 [Aug. 13, 1994] by Moore show examples of this practice. These employ standardized plugs and ferrite elements for filtering, but are inherently invasive devices. By definition they create terminations and anomalies on the wire or cable and add cost to the manufacturing process by requiring connectors to be added to the cable.

From the background and prior art described above, it can be seen that what is needed is a feedthrough device that creates significant production efficiencies by allowing, in a single process, a wire, cable, tube or other elongated component being passed through an opening in a chassis, panel, circuit board, bulkhead or other planar or non-planar surface to be easily and efficiently insulated, secured, strain relieved, optionally filtered of various user-selectable signals and optionally provided user-selectable transient over-voltage protection, all without requiring the wire, cable, tube or other elongated component to be interrupted or cut. It can also be seen that additional production efficiencies can be gained if that same device can act as a stand-alone filter when placed onto a wire or cable that is not being passed through an opening in a surface, since this would afford a manufacturer the opportunity to stock a single device that is made available for multiple applications, thus eliminating the higher cost of stocking, accounting for and tracking multiple components.

### SUMMARY

Accordingly it is an object of this invention to provide a feedthrough that allows a wire, cable, tube or other elongated component being passed through an opening in a chassis, panel, circuit board, bulkhead or other planar or non-planar surface or obstacle to be easily and efficiently physically and electrically insulated, secured and strain relieved.

It is an additional object of this invention to include a locating flange on a feedthrough to assure stability and proper alignment when mounted against a planar or non-planar surface.

Further, it is an object of this invention to provide a feedthrough that can accommodate a wide range of thicknesses of the planar or non-planar surface through which the feedthrough passes.

It is even further an object of this invention to provide a feedthrough that is not restricted to use with flat planar surfaces, allowing use of the invention when passing a wire, cable, tube or other elongated object through a surface that is either generally planar or non-planar, accommodating widely varying surface textures in either case.

Another object of this invention is to provide a feedthrough that can be used for wires, cables, tubes or other elongated components of moderately different diameters.

A further object of this invention is to accommodate use with a single wire (solid or stranded conductor), multiple individual wires and cables in various combinations, multiple-conductor cable, and coaxial cable.

Yet another object of this invention is to provide an article that may be used as a filter-mounting feedthrough device for wires or cables, regardless of whether the wires or cables are being passed through an obstacle.

A further object of this invention is to provide a feedthrough that allows user-selectable signal suppression (filtering) elements to be included into the installed instance of the invention.

It is even further an object of this invention to provide a feedthrough that has an area for mounting one or more coated or non-coated ferrite beads or other concentrically mounted object, the mounting area accommodating multiple sizes of beads provided that the inner diameter of the bead is sufficiently large to fit over the outside diameter of the bead mounting area of the feedthrough.

Another object of this invention is to provide a feedthrough with signal filtering capability that does not require a face of the obstacle through which the wire or cable passes to be electrically conductive.

An additional object of this invention is to provide a feedthrough that does not require a wire, cable, tube or other elongated object being passed through it to be additionally interrupted, cut, connectorized or soldered.

It is also an object of this invention to provide a feedthrough with tapered exit holes to provide protection from damage of the wire, cable, tube or other elongated component if flexed as it leaves the feedthrough.

A further object of this invention is to provide a feedthrough that optionally includes an adhesive surface to secure the feedthrough from rotating once placed through a substantially planar surface, additionally helping to temporarily secure the feedthrough to the substantially planar surface during the installation process, making installation of the feedthrough easier and faster.

It is yet another object of this invention to provide a feedthrough with a simple snap-together installation and assembly process that requires no use of tools and works well with both manual and automated assembly processes.

It is further an object of this invention to provide a feedthrough that can be manufactured in various colors to allow the user to “color-code” wires, cables, tubes or other elongated objects by passing the object through a specifically colored instance of the feedthrough. This process of using color-coding is also valuable for allowing identification of the specific properties of the feedthrough in use.

Finally, it is an object of this invention to provide an article and method for reducing manufacturing costs by combining several traditionally individual manufacturing steps into a single process, wherein a wire, cable, tube or other elongated component is passed through an opening in a planar or non planar surface or object, insulated, secured, strain relieved, optionally filtered of various user-selectable signals and optionally provided user-selectable transient over-voltage protection.

The present invention, by meeting the objectives listed above, provides the functions features a-nd benefits described herein.

The present invention offers the advantage of being an easily installed, durable, insulating, optionally filtering, optionally color coded feedthrough that will accommodate a relatively wide range of obstacle thicknesses, surface textures and obstacle opening sizes and shapes, as well as accommodating a relatively wide range of exterior dimensions and shapes of whatever object is passed through the feedthrough. The feedthrough of this invention will function as it passes through flat or curved surfaces of an obstacle.

Each instance of the present invention can internally accommodate a reasonably broad range of diameters of a cable, wire, tube or other elongated object while still appropriately clamping or securing the object. This invention can include a beveled or rounded exit hole at each end to allow easy and safe flexing of the cable, wire, tube or other elongated object as it exits the feedthrough. The beveled exit holes also make it easier to thread an elongated object, such as a wire, through the installed feedthrough.

Having no electrical failure mode, the feedthrough of this invention will not allow, nor will it create, unwanted electrical shorts between conductors or filtering elements and electrical ground.

From the end-user's perspective, the present invention is an inexpensive, easy to use feedthrough that can be applied in varying applications, optionally providing user-selectable filtering characteristics. The article of this invention is small and lightweight, allowing manufacturers or individuals using the feedthrough in production or assembly to easily and efficiently store and handle their inventory of this invention. The broad range of this invention's application allows the manufacturer or individual store a smaller variety of parts in inventory, thus increasing overall manufacturing and assembly efficiency.

Additionally, this invention is physically structured in a way that allows its elements to be mounted on an industrial tape or roll, from which they may then be placed by automated assembly machines, making the invention suitable for use in mass-production manufacturing techniques.

If filtering properties are not needed, the invention may be installed without inclusion of filtering elements while retaining the desired mechanical features.

The invention can be used in different colored instances to “color-code” individual (or groups of) wires, cables, tubes or other elongated objects while taking advantage of the invention's many other benefits.

The present invention can slide over the end of existing open-ended wires, cables, tubes or other elongated objects without requiring any physical modifications to the objects. The feedthrough of this invention can also be secured onto a wire, cable, tube or other elongated object (that is not passing through a surface) while maintaining all of the filtering flexibility that is provided in panel use.

The present invention, when installed, is relatively immune to vibration and temperature extremes. Additionally, the filtering performance of the invention (if the filtering option is applied) is not degraded under extreme temperature or vibration conditions.

This invention can securely clamp a wire, cable, tube or other elongated object in place as it passes through a surface, preventing unwanted tension or compression along the object, or alternately, applying specific intended tension or compression along the object. This advantage is gained while preventing the object from being chafed or otherwise damaged when passing through a surface opening. Additionally, the degree of clamping action on the wire, cable, tube or other elongated object can be varied so that controlled slippage can be introduced into the feedthrough object. This allows for limited movement, or to prevent overstress, or dislodging, of the feedthrough.

During the first step of its installation process, the feedthrough of this invention secures itself to the surface through which it is passed (when used in this manner), freeing the installer from the task of manually securing the feedthrough while proceeding with the rest of the installation steps. This increases the speed of installation of the invention, creating production efficiencies.

Due to the features of this invention, the feedthrough is reusable, which clearly provides a great advantage to the end-user. For ecological reasons as well, this advantage is very important, since reuse of the feedthroughs prevents them from being added to landfill mass.

Removal of the feedthrough from an installed location is relatively simple, allowing convenient use of the invention in prototyping applications or any other situation where the feedthrough will be uninstalled and reused. In addition, the main body of the feedthrough may be left installed while other components of the device are changed or swapped, making installed unit configuration changes much easier and faster. In one embodiment of the invention, reversing the orientation of a locking ring causes it to be more easily removed, while maintaining enough grip while installed to be appropriate for temporary applications (such as prototype installations where subsequent removal or reconfiguration is likely). Providing a consistent distinguishable marking, feature or color on at least one face of a locking ring allows quick and easy inspection of an installed device to determine whether a permanent or temporary installation has been made. In the same regard, during installation of the locking ring, such a marking, feature or color insures that the installer can easily distinguish the locking characteristic of the ring as used.

The invention when installed on the visible exterior of a commercial product, presents a small, inconspicuous (color and shape optional) flange on the outside of the product, eliminating the need to hide or disguise (for aesthetic reasons) the externally visible portion of the invention.

This invention is a feedthrough that allows readily available commercial ferrite beads or toroids to be easily assembled and secured onto a wire or cable (whether on not the wire or cable is passing through a surface). Any combination of beads, toroids or other signal suppressing arrangements that will concentrically mount on the feedthrough may be used to create desired filtering characteristics.

Using inherently stable and inert ferromagnetic devices with the invention, the user is offered an exceptional range of filtering configurations. Already commercially available are a wide variety of frequency and attenuation values provided by ferrite beads with sizes and shapes appropriate for use with this invention. These ferrite beads also provide (to a wire or cable passing through them) a significant degree of protection from power surges and voltage spikes.

Providing the end-user the flexibility to selectively incorporate a mixture of ferrite beads with differing properties, the invention allows easy construction of many commonly applied and useful filters, some of which are described below.

Using this invention, a feedthrough providing band-pass filtering can be constructed by using ferrite beads whose frequency ranges are above and below the pass-band. The level of attenuation of the filtering provided can be easily varied by the addition or removal of filtering elements during the assembly process.

A wide bandwidth of filtering can be obtained by using beads whose center frequencies of attenuation are separated but whose band-stop edges intersect. A high Q, or narrow bandwidth filter can be constructed by using two or more beads that operate in the same frequency range.

A tuned circuit can be constructed by using the device as an inductive end of a conductive rod, cable or wire, in conjunction with inherent or applied capacitive elements.

When multiple instances of this invention are configured with specific values of inductive components and clamped onto a wire at specific regular intervals the wire acts as a series-fed resonant circuit. When mounted at the end of parallel wires, this arrangement allows the array to act as a parallel resonant circuit.

This invention also has the advantages of being easy and inexpensive to produce with readily available raw materials, lending itself to high-speed mass production.

A manufacturer can efficiently produce this invention in a wide variety of dimensions, proportions, elemental shapes, colors and optional configurations, each variety accommodating a specific application or a range of applications. This broadens the base of the invention's commercial market.

Accordingly, it can be appreciated that the present invention provides significant advantages over other feedthroughs and filtering devices currently available in the art. The broad group of features, functions and benefits provided by the present invention are not wholly found, nor anticipated, in the feedthrough and filtering devices that constitute prior art. Still further advantages will become apparent from a consideration of the ensuing description and drawings of the present invention, where like designations represent like elements.

### BRIEF DESCRIPTION OF THE DRAWINGS

FIG. 1 shows a profile view of the preferred embodiment of the invention in operation, clamping ferrite bead 501 into the location where the invention is installed and secured to a surface through which it passes.

FIG. 2 shows a profile view of the invention in operation clamped onto a wire as a stand-alone filter according to an alternative embodiment.

FIG. 3 shows a detailed, exploded side view of an alternative embodiment of the invention, including the additional elements of tapered exit hole 108, locating flange 102, adhesive coating 109, locking ring 300, and compressible disk 400.

FIG. 3A shows an end view of an alternative embodiment of sleeve 100 of the invention, including restraining flange edge hole 110, shown with slots 106 placed away from the viewer in relation to restraining flange 101.

FIG. 3B shows an end view of an alternative embodiment of sleeve 100 of the invention, including restraining flange edge hole 110, shown with restraining flange 101 placed away from the viewer in relation to slots 106.

FIG. 3C shows an end view of an alternative embodiment of sleeve 100 of the invention, where sleeve 100 includes a non-circular locating flange 102, shown with restraining flange 101 placed away from the viewer in relation to slots 106.

FIG. 4 shows a side view of an alternative embodiment of the invention, where restraining flange 101 is enlarged and reshaped to accommodate mounting onto a standard cable television wiring wall box.

FIG. 4A shows an end view of an alternative embodiment of the invention, where restraining flange 101 is enlarged and reshaped to accommodate mounting onto a standard cable television wiring wall box, oriented with restraining flange 101 placed away from the viewer in relation to slots 106.

FIG. 5 shows a side view of sleeve 100 of an alternative embodiment of the invention, with sleeve 100 including restraining flange compressible section 111.

FIG. 5A shows a side view of cap 200 of an alternative embodiment of the invention, with cap 200 including compressible cap section 205.

FIG. 5B shows a side view of locking ring 300 of an alternative embodiment of the invention, with locking ring 300 including compressible locking ring section 303.

FIG. 6 shows an installed alternate embodiment of the invention, where cap 200 also includes cap hood 204, which sleeves over other elements of the feedthrough during the installation process to provide additional protection and insulation.

FIG. 6A shows a side view of cap 200 according to an alternate embodiment of the invention, where cap 200 also includes cap hood 204.

FIG. 6B shows an end view of cap 200 according to an alternate embodiment of the invention, where cap 200 also includes cap hood 204, shown with tapered compression bore section 203 placed away from the viewer in relation to cap hood 204.

FIG. 7 shows a side view of a planar surface 600 with a planar surface locking opening 602 that mates with a restraining flange locking protuberance 112 shown on restraining flange 101 of sleeve 100 according to an alternate embodiment of the invention.

FIG. 7A shows an end view of sleeve 100 of an alternate embodiment of the invention, where restraining flange 101 of sleeve 100 includes a restraining flange locking protuberance 112.

### DETAILED DESCRIPTION OF THE PREFERRED EMBODIMENT

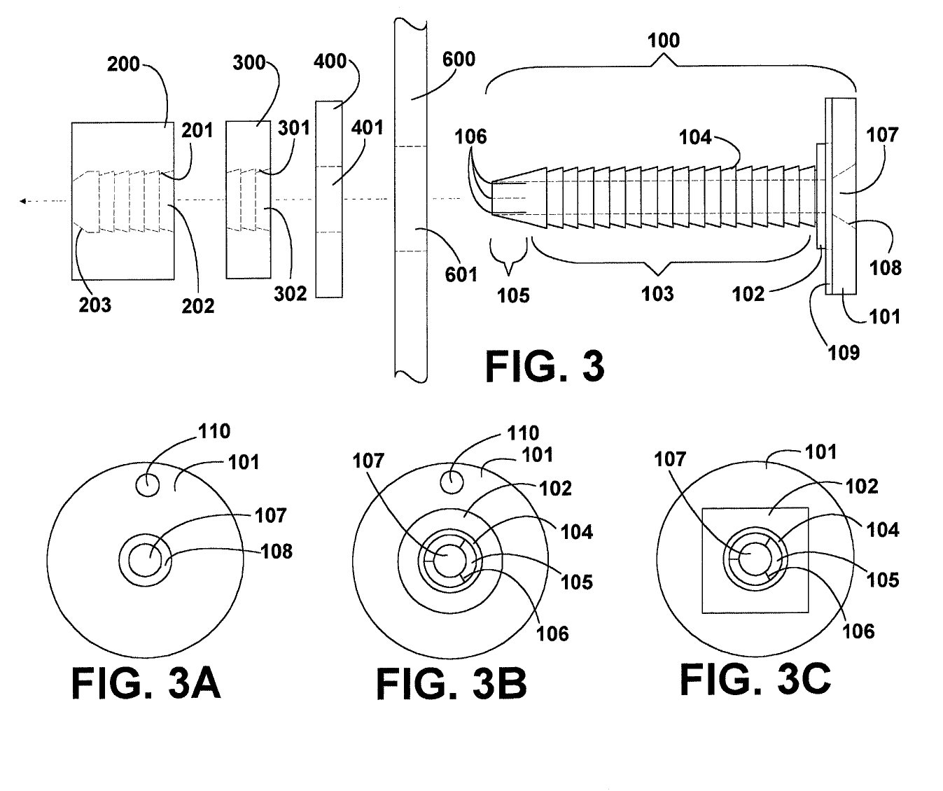

Referring first to FIG. 3, a detailed, exploded side view of an alternative embodiment of the invention is shown. In this embodiment, sleeve 100 is shown with a restraining flange 101, locating flange 102, locking engagement area 103, sleeve teeth 104, tapered clamping tabs 105, slots 106, sleeve bore 107, tapered exit hole 108 and adhesive coating 109.

Also shown in FIG. 3 are cap 200, cap teeth 201, cap bore 202, locking ring 300, locking ring teeth 301, locking ring bore 302, compressible disk 400, compressible disk bore 401, planar surface 600 and planar surface opening 601.

Sleeve 100 is comprised of several required and optional elements in the embodiment of the invention shown in FIG. 3.

Tapered exit hole 108 of sleeve 100 bisects sleeve bore 107, sleeve bore 107 being a generally cylindrical hollowed out area along the entire longitudinal center of sleeve 100. The minimum diameter of tapered exit hole 108 equals the substantially constant diameter of sleeve bore 107. While optional, when present, tapered exit hole 108 minimizes undesirable mechanical stress on objects that are being bent away from the longitudinal axis of sleeve bore 107 as they exit this end of the feedthrough.

Adhesive coating 109 is applied the face of restraining flange 101 that is adjacent to locating flange 102. Adhesive coating 109 prevents easy rotation of sleeve 100 once installed, providing as well a convenient temporary method for holding sleeve 100 in place against planar surface 600 during installation while the installer proceeds with placement of the remainder of the elements of the invention onto sleeve 100.

Locating flange 102 is used as a guide for properly centering sleeve 100 into planar surface opening 601 of planar surface 600, into which sleeve 100 is installed. Positive seating of locating flange 102 into planar surface opening 601 of planar surface 600 causes centering of sleeve 100 through planar surface opening 601. The presence of locating flange 102 is only advantageous in applications where the invention is used as a feedthrough passing through an opening or depression in an obstacle where such opening is dimensioned to allow positive seating of locating flange 102, such as when sleeve 100 is inserted through planar surface opening 601 of planar surface 600.

Sleeve 100 also includes locking engagement area 103. Locking engagement area 103 includes many instances of sleeve teeth 104 concentrically encircling locking engagement area 103. Sleeve teeth 104 are positioned and dimensioned to engage with cap teeth 201 of cap 200 and locking ring teeth 301 of locking ring 300 when these elements of the invention are assembled onto sleeve 100 during the installation process.

Tapered clamping tabs 105 and slots 106 are located at the longitudinal end of sleeve 100 that is opposite the end of sleeve 100 where restraining flange 101 is located. Sleeve bore 107 continues through the center of the area of sleeve 100 where tapered clamping tabs 105 and slots 106 are located. Tapered clamping tabs 105 provide clamping action onto an object passing through sleeve bore 107 only when tapered clamping tabs 105 are sufficiently deflected inward toward the longitudinal axis of sleeve bore 107 by being forced through tapered compression bore section 203 of cap 200.

Note that locating flange 102, tapered exit hole 108 and adhesive coating 109 are optional elements of sleeve 100. These optional elements of sleeve 100 are only necessary for certain specific applications. Locking ring 300 and compressible ring 400 are also optional components of the present invention, providing benefits in only specific applications.

Normal assembly of this embodiment of the invention would include sliding sleeve 100 through planar surface opening 601 of planar surface 600 until restraining flange 101 stops forward movement of sleeve 100 as restraining flange 101 encounters planar surface 600. Adhesive coating 109 temporarily secures restraining flange 101 to planar surface 600. Locating flange 102 passes at least partially into planar surface opening 601 of planar surface 600, centering sleeve 100 through planar surface opening 601 of planar surface 600. At this point in the installation process, compressible disk 400 is slid onto sleeve 100 until compressible disk 400 rests flush up against the side of planar surface 600 opposite where restraining flange 101 rests. The compressible disk bore 401 of compressible disk 400 is dimensioned to allow easy sliding of compressible disk 400 over the locking engagement are 103 of sleeve 100. After this, locking ring 300 is slid onto sleeve 100 until locking ring 300 presses tightly against the side of compressible disk 400, causing some compression of compressible disk 400. The compression of compressible disk 400 creates back-pressure that causes locking ring teeth 301 (located inside locking ring bore 302) to transfer this back-pressure to sleeve teeth 104 of sleeve 100, thereby pulling restraining flange 101 tighter against planar surface 600, thus strongly securing the entire assembly of the invention into its installed location through planar surface opening 601 of planar surface 600. Following this, cap 300 is slid onto sleeve 100, only to the point just prior to causing engagement between tapered clamping tabs 105 of sleeve 100 and tapered compression bore section 203 of cap 200. In this position, cap 200 is held in place through the engagement of cap teeth 201 with sleeve teeth 104 where locking engagement area 103 of sleeve 100 passes through cap bore 202 of cap 200. At this point in the assembly process, any elongated object of appropriate dimensions can be passed through sleeve bore 107 and tapered exit hole 108, and positioned longitudinally as desired. Finally, to secure an elongated object into its longitudinal position, cap 200 is pressed further onto the locking engagement area 103 of sleeve 100, forcing tapered clamping tabs 105 of sleeve 100 into tapered compression bore section 203 of cap 200. This action causes tapered clamping tabs 105 of sleeve 100 to deflect inward onto the outer surface of the elongated object, thus securing the elongated object where its surface makes contact with tapered clamping tabs 105 of sleeve 100.

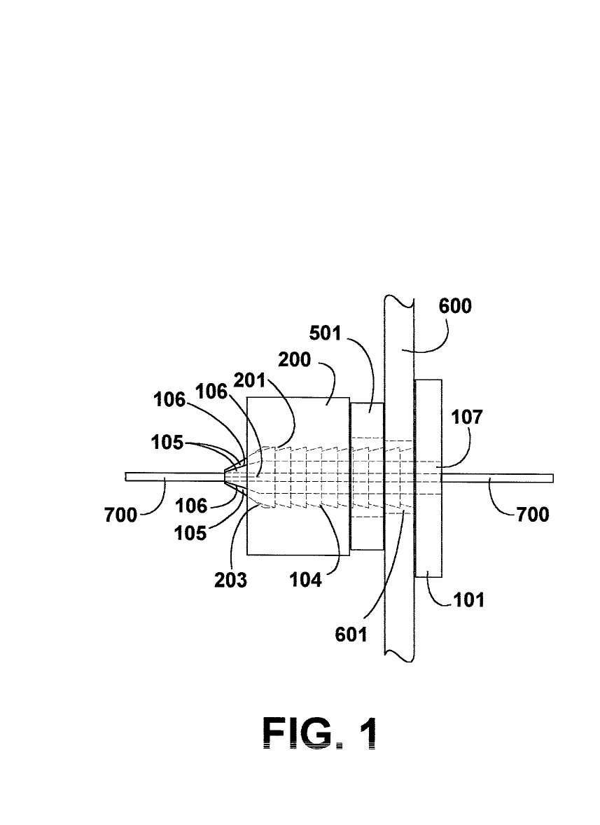

Referring now to FIG. 1, a preferred embodiment of the present invention is depicted. In this depiction, the feedthrough of this invention is shown installed through planar surface opening 601 of planar surface 600, securing first ferrite bead 501 to one side of planar surface 600 and providing a filtering feedthrough that secures and insulates feed-through object 700 as it passes through sleeve bore 107.

Referring again to FIG. 1, it can be seen that in this embodiment of the invention a sleeve 100 consists of a hollow tube with a transverse circular or alternately shaped restraining flange 101 at one end of the longitudinal axis of sleeve 100.

Restraining flange 101 has a larger outside diameter than the nominal outside diameter of sleeve 100. Concentrically encircling a portion of the external longitudinal surface of sleeve 100 is a group of asymmetric, sleeve teeth 104. Sleeve teeth 104 are attached at regular intervals to the exterior surface of sleeve 100 in the area between restraining flange 101 on one end and tapered clamping tabs 105 on the other. The segment of sleeve 100 that includes sleeve teeth 104 constitutes a locking engagement area 103 (shown and designated in FIG. 3). Sleeve teeth 104 of locking engagement area 103 interlock (upon engagement) with a set of cap teeth 201 that line at least a portion of cap bore 202 inside of cap 200. This produces a ratcheting action whereby a disproportionately high force is required to remove cap 200 from sleeve 100 once assembled together, compared to the minor force required for assembly of cap 200 onto sleeve 100. During installation of the invention, ratcheting of cap teeth 201 over sleeve teeth 104 substantially secures cap 200 into place against first ferrite bead 501.

Tapered clamping tabs 105 are located on the longitudinal end of sleeve 100 opposite the end where restraining flange 101 is located.

Now referring briefly again to FIG. 3, tapered clamping tabs 105 of sleeve 100 are shown in their non-operational configuration, separated from one another by slots 106. Tapered clamping tabs 105, combined with slots 106, form an area of sleeve 100 that is generally conical in shape, with the smaller diameter of the conically shaped area located toward the longitudinal end of sleeve 100 that is opposite the end of sleeve 100 where restraining flange 101 is located. The larger exterior diameter of this conical area matches the nominal exterior diameter of sleeve 100. Tapered clamping tabs 105 are individually connected at one end to the body of sleeve 100, each of the clamping tabs 105 extending away from the main body of sleeve 100, terminating in free space. The tapered shape of clamping tabs 105 allows them to be collectively forced to deflect inward toward the longitudinal axis of sleeve bore 107, thereby narrowing the exit diameter of sleeve bore 107 at this end of sleeve 100.

Now referring back to FIG. 1, it can be seen that, after passing freely through cap bore 202, tapered clamping tabs 105, through engagement and interaction with tapered compression bore section 203 of cap 200, are forced to deflect inwardly sufficiently to strongly engage the exterior of feed-through object 700, thereby substantially securing object 700 into position.

The diameter of the narrowed exit of sleeve bore 107 (provided by tapered clamping tabs 105 in operation) is easily adjustable, determined primarily by the depth to which tapered clamping tabs 105 are inserted into tapered compression bore section 203 of cap 200. The specific distances between each of sleeve teeth 104 of sleeve 100 determine the granularity of this adjustment. Alternately or cooperatively, the specific distances between each of cap teeth 201 of cap 200 can also determine the final attainable granularity of this adjustment. In the preferred embodiment of the invention, cap teeth 201 and sleeve teeth 104 are substantially mated in their engagement dimensions, including size, shape and distance between teeth. Clamping action of tapered clamping tabs 105 onto the exterior surface of feedthrough object 700 is continuously maintained after assembly since cap 200 is held in place by the locking nature of engagement between cap teeth 201 of cap 200 and sleeve teeth 104 on sleeve 100.

Referring again to FIG. 1, first ferrite bead 501 is shown installed encircling a portion of locking engagement area 103 (referenced in FIG. 3) of sleeve 100, with planar surface 600 providing a barrier to one side of first ferrite bead 501. Installed cap 200 can be seen to provide a barrier on the opposite side of first ferrite bead 501, thereby preventing first ferrite bead 501 from sliding along the longitudinal dimension of sleeve 100.

In FIG. 1 it can be seen that the specific dimensions of the individual elements and components of this instance of the invention are such that an appropriate fit is made to the specific application of the feedthrough. It would be obvious to anyone reasonably skilled in the art that the scaling and specific dimensions of the elements of the feedthrough of this invention can be altered to most appropriately fit a specific application without straying outside the bounds of the features, benefits and functions claimed herein. For instance, tapered clamping tabs 105 can have an interior surface that is “roughed” or irregular to provide a better grip where they engage with the exterior surface of feed-through object 700. Tapered clamping tabs 105 can also have rounded or softened edges to prevent undesired chafing of the exterior of feed-through object 700. Additionally, the specific shape, thickness and outside dimensions of restraining flange 101 can vary according to the specific application while still retaining the features, benefits and functions claimed herein.

It can be seen that elimination of first ferrite bead 501 from this assembly, provided the length of cap 200 is sufficiently increased, provides a non-filtering embodiment of the insulating and securing feedthrough of this invention.

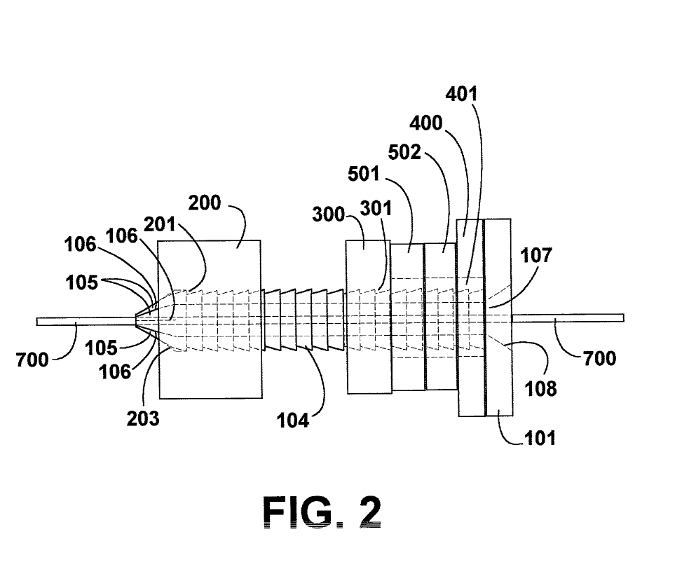

Referring now to FIG. 2, an alternative embodiment of the invention is shown, where the invention is securing first ferrite bead 501 and second ferrite bead 502 onto a feedthrough object 700, providing signal filtering for feedthrough object 700 while not passing through a panel or surface. In this instance, feedthrough object 700 is assumed to be a free-hanging electrical wire in need of signal filtering. As can be seen in FIG. 2, the length of locking engagement area 103 (referenced in FIG. 3) of sleeve 100 can be dimensioned to allow inclusion of one, two or more ferrite beads or other similarly shaped items into the assembly of the present invention. The adjustable final positioning of locking ring 300 provides flexibility to similarly lock variant numbers of items of variant dimensions into place around locking engagement area 103 of sleeve 100.

In the embodiment of the invention shown in FIG. 2, restraining flange 101 provides an end-stop for compressible disk 400, first ferrite bead 501, second ferrite bead 502 and locking ring 300. Compressible disk bore 401 of compressible disk 400 is sized to appropriately encircle sleeve teeth 104 without forcing ratcheting engagement of compressible disk 400 with sleeve teeth 104 as compressible disk 400 is slid over sleeve teeth 104 during the assembly process. The internal bores of first ferrite beat 501, second ferrite bead 502 are also sized appropriately so as not force ratcheting engagement of these beads with sleeve teeth 104 during the assembly process.

In the installation process of the application shown in FIG. 2, the feedthrough of this invention is pre-assembled, except that tapered compression bore section 203 of cap 200 is not fully engaged with tapered clamping tabs 105, allowing tapered clamping tabs 105 to remain is their natural, non-deflected position, thereby preventing clamping action. This allows the entire pre-assembled feedthrough to slide easily onto feedthrough object 700.

In this embodiment of the present invention, pre-assembly consists of sliding tapered clamping tabs 105, slots 106 and locking engagement area 103 of sleeve 100 through compressible disk bore 401 of compressible disk 400, then through the bores of second ferrite bead 502 and first ferrite bead 501, sliding each of these items further onto locking engagement area 103 of sleeve 100 until compressible disk 400 rests against restraining flange 101, second ferrite bead 502 rests against compressible disk 400 and first ferrite bead 501 rests against second ferrite bead 502. Following this, locking ring 300 is slid onto locking engagement area 103 of sleeve 100, causing locking ring teeth 301 to engage sleeve teeth 104. Locking ring 300 is then slid further onto sleeve 100 until locking ring 300 presses tightly against the side of first ferrite bead 501, causing some compression of compressible disk 400 as it is squeezed tightly between second ferrite bead 502 and restraining flange 101. The compression of compressible disk 400 creates back-pressure that causes locking ring teeth 301 to transfer this back-pressure to sleeve teeth 104 of sleeve 100, thereby pulling restraining flange 101 tighter against second ferrite bead 502, thus strongly securing first ferrite bead 501 and second ferrite bead 502 into position around locking engagement area 103 of sleeve 100. Following this, cap 300 is slid onto sleeve 100, only to the point just prior to causing engagement between tapered clamping tabs 105 of sleeve 100 and tapered compression bore section 203 of cap 200. In this position, cap 200 is held in place through the engagement of cap teeth 201 with sleeve teeth 104. This completes the pre-assembly process for the embodiment of the invention shown in FIG. 2.

After completion of pre-assembly, feed-through object 700 is slid through tapered exit hole 108 and sleeve bore 107 and out the other end of the pre-assembled feedthrough of the invention. The pre-assembled feedthrough is positioned longitudinally as desired onto feed-through object 700. Finally, to secure the pre-assembled feedthrough into its longitudinal position on feedthrough object 700, cap 200 is pressed further onto the locking engagement area 103 of sleeve 100, forcing tapered clamping tabs 105 of sleeve 100 into tapered compression bore section 203 of cap 200. This action causes tapered clamping tabs 105 of sleeve 100 to deflect inward onto the outer surface of the feed-through object 700, securing feed-through object 700 where its surface makes contact with tapered clamping tabs 105 of sleeve 100. Thus installation of the pre-assembled feedthrough of this invention is accomplished.

Alternately, in this embodiment of the invention, each component of the invention can be placed individually (in proper order) onto feed-through object 700, completing assembly of the feed-through of this invention while its components encircle feedthrough object 700.

Now referring to FIG. 3A an end view of an alternative embodiment of sleeve 100 of the invention is seen (including optional restraining flange edge hole 110), with slots 106 placed away from the viewer in relation to restraining flange 101. In this embodiment, tapered exit hole 108 is centered in restraining flange 101. The narrow end of tapered exit hole 108 meets with one end of sleeve bore 107.

In this embodiment of the invention, restraining flange edge hole 110 is included to allow an external object (such as string, wire or similar item) to be attached to restraining flange 101 of sleeve 100. This feature is useful for introducing intentional latitudinal strain, or restricting latitudinal movement of the invention when installed in free space on a feedthrough object 700, as shown in FIG. 2.

Now referring to FIG. 3B an end view of an alternative embodiment of sleeve 100 of the invention is seen (including optional restraining flange edge hole 110, but excluding adhesive coating 109), shown with restraining flange 101 placed away from the viewer in relation to slots 106. This is essentially an opposite view of sleeve 100 that is shown in FIG. 3A. In the view shown in FIG. 3B, it can be seen that restraining flange 101, locating flange 102, sleeve teeth 104 and tapered clamping tabs 105 all surround sleeve bore 107 of sleeve 100. Slots 106 separate tapered clamping tabs 105 from one another. Restraining flange 101 also contains restraining flange edge hole 110.

Now referring to FIG. 3C, what is shown is an end view of an alternative embodiment of sleeve 100 of the invention (where sleeve 100 includes a noncircular locating flange 102, but excludes adhesive coating 109), shown with restraining flange 101 placed away from the viewer in relation to slots 106. In the view shown in FIG. 3C, it can be seen that restraining flange 101, locating flange 102, sleeve teeth 104 and tapered clamping tabs 105 all surround sleeve bore 107 of sleeve 100. Slots 106 separate tapered clamping tabs 105 from one another. Note that in this embodiment, locating flange 102 is square shaped. This is only one possible alternate shape that locating flange 102 can take without straying from the features, functions and benefits claimed herein.

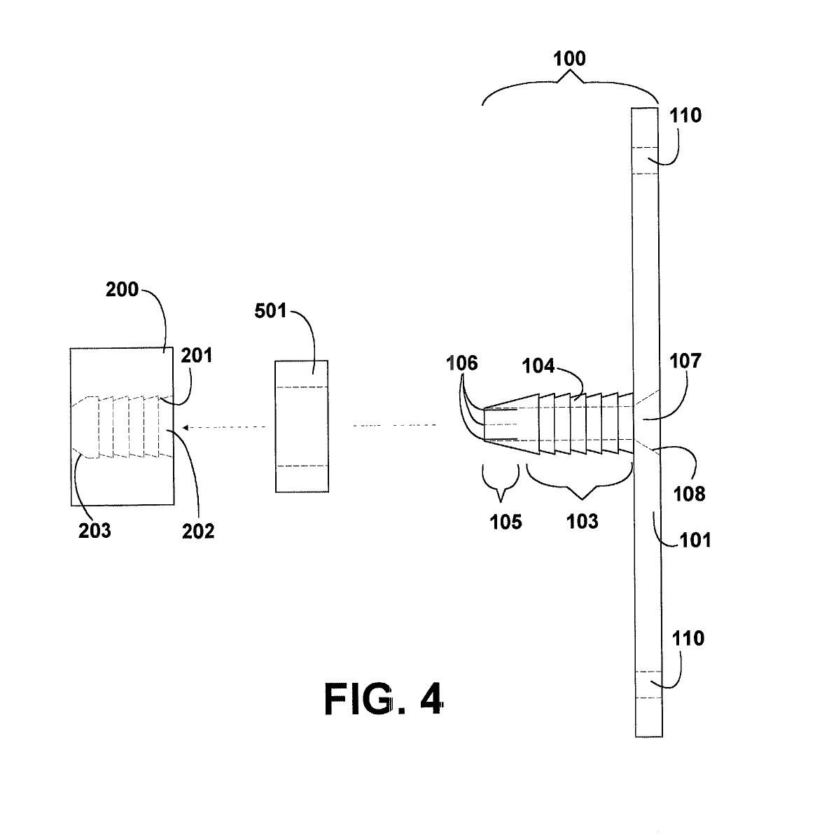

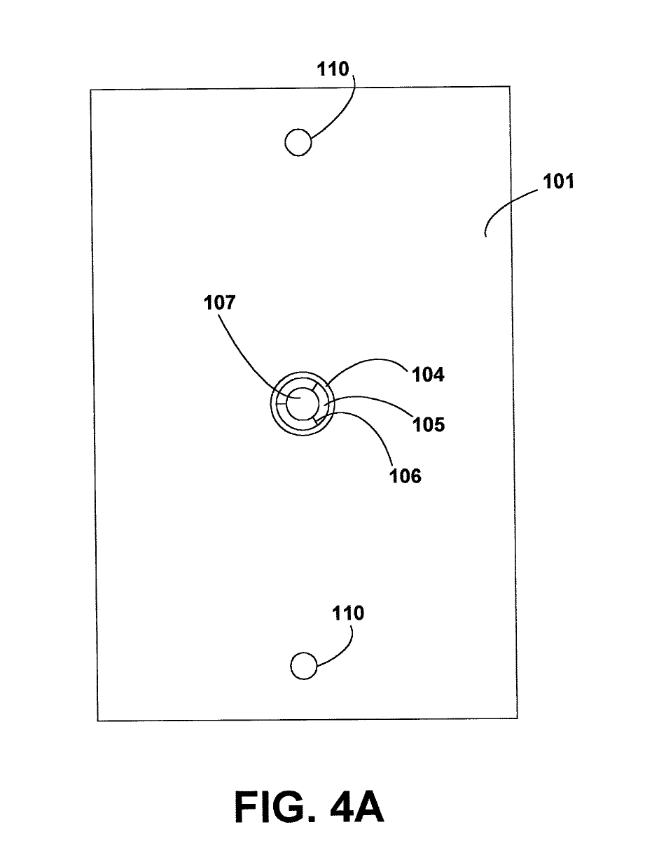

Now referring to FIG. 4, what is shown is a side view of an alternative embodiment of the invention, where restraining flange 101 is enlarged and reshaped to accommodate mounting onto a standard cable television wiring wall box. Restraining flange 101 of this embodiment of the invention includes two copies of restraining flange edge hole 110. Restraining flange edge holes 110 are positioned on restraining flange 101 in such a way as to allow convenient alignment with mounting holes provided in standard cable television wiring boxes. Using mounting screws provided with all standard cable television wiring boxes to mount restraining flange 101 to an existing cable television wiring box provides a method of securing the invention into the box.

In this embodiment of the invention, restraining flange 101 is rectangular shaped, with dimensions that fit properly against the front of a standard cable television wiring box. Once assembled, first ferrite bead 501 rests directly against restraining flange 101 of sleeve 100, being held in place by cap 200. Tapered compression bore section 203 of cap 200, being sufficiently engaged with tapered clamping tabs 105, initiates clamping action of tapered clamping tabs 105 onto the surface of feedthrough object 107 (not shown here), thereby securing feedthrough object 107 longitudinally in place where it makes contact with inwardly deflected tapered clamping tabs 105. In this instance, feedthrough object 107 is assumed to be a video cable.

Now referring to FIG. 4A, what is shown is an end view of an alternative embodiment of sleeve 100 of the invention, shown oriented with restraining flange 101 placed away from the viewer in relation to slots 106. In this embodiment of the invention, restraining flange 101 of sleeve 100 is enlarged and reshaped to accommodate mounting onto a standard cable television wiring wall box. In the view shown in FIG. 4A, it can be seen that restraining flange 101, sleeve teeth 104 and tapered clamping tabs 105 all surround sleeve bore 107 of sleeve 100. Slots 106 separate tapered clamping tabs 105 from one another. Note that in this embodiment, restraining flange edge holes 110 are positioned on restraining flange 101 in such a way as to allow convenient alignment with mounting holes provided in standard cable television wiring boxes. This is only one possible alternate shape that restraining flange 101 can take without straying from the features, functions and benefits claimed herein.

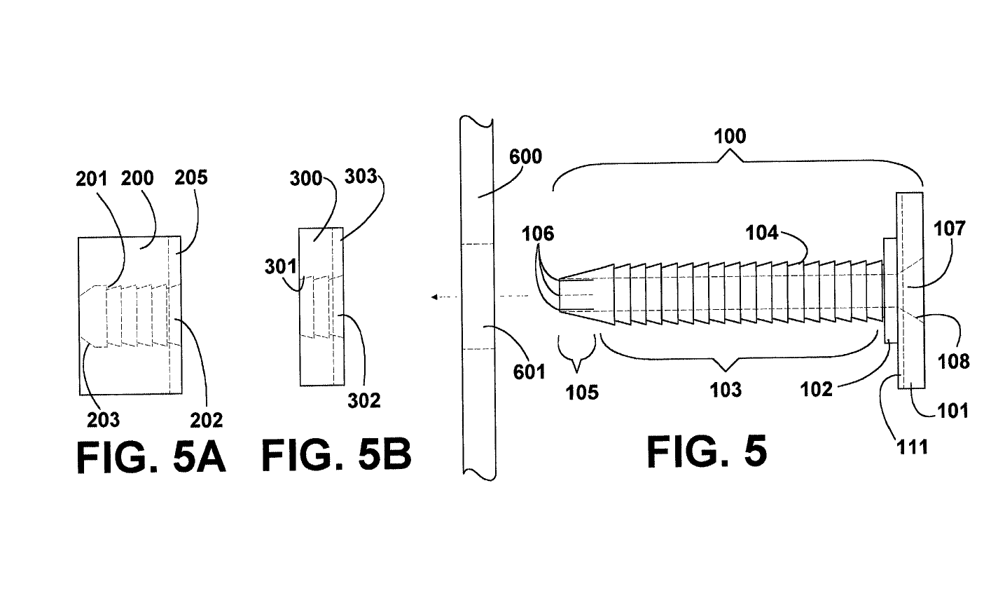

Now referring to FIG. 5, what is shown is a side view of sleeve 100 of an alternative embodiment of the invention, with sleeve 100 including restraining flange compressible section 111. In this embodiment, restraining flange 101 of sleeve 100 includes a restraining flange compressible section 111 that eliminates the need for optional compressible disk 400, since restraining flange compressible section 111 can be compressed between the main body of restraining flange 101 and whatever object or invention component is pressed against the opposing side of restraining flange compressible section 111.

Referring now to FIG. 5A, what is shown is a side view of cap 200 of an alternative embodiment of the invention, with cap 200 including compressible cap section 205. In this embodiment, cap 200 includes a compressible cap section 205 that eliminates the need for optional compressible disk 400, since compressible cap section 205 can be compressed between the main body of cap 200 and whatever object or invention component is pressed against the opposing side of compressible cap section 205. Compressibility may be obtained through the use of alternate methods.

Now referring to FIG. 5B, what is shown is a side view of locking ring 300 of an alternative embodiment of the invention, with locking ring 300 including compressible locking ring section 303. In this embodiment, locking ring 300 includes a compressible locking ring section 303 that eliminates the need for optional compressible disk 400, since compressible locking ring section 303 can be compressed between the main body of locking ring 300 and whatever object or invention component is pressed against the opposing side of compressible locking ring section 303.

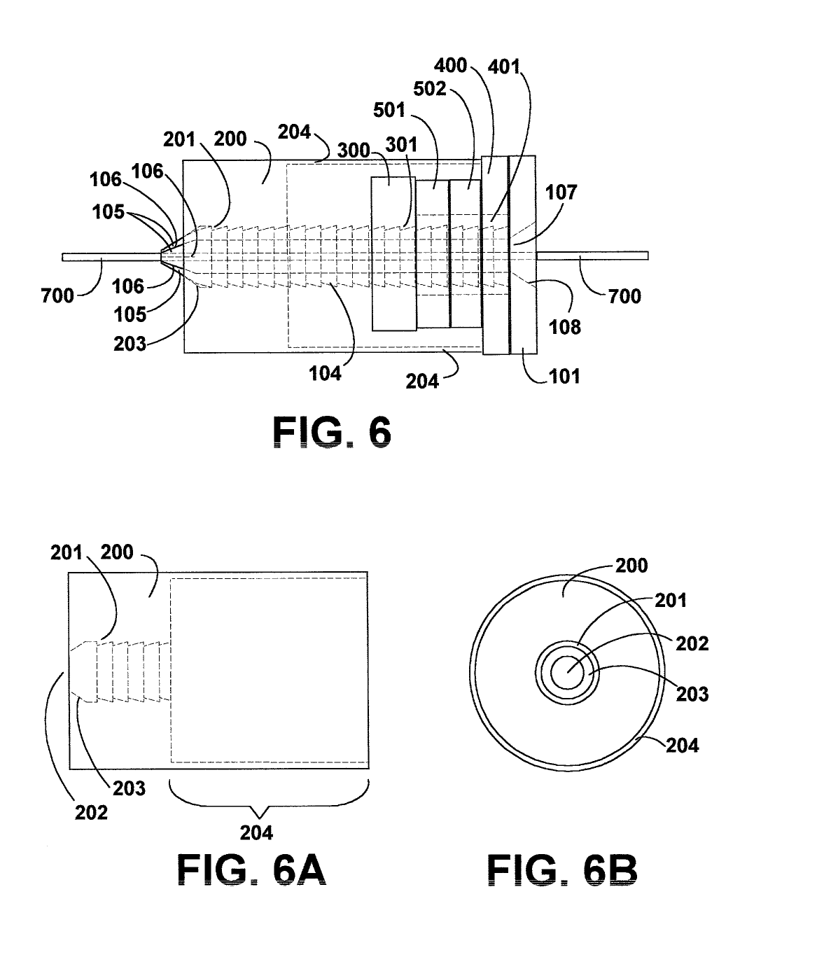

Now referring to FIG. 6, what is shown is an installed side view of an alternate embodiment of the invention, where cap 200 also includes cap hood 204, which sleeves over other elements of the feedthrough as part of the installation process to provide additional protection and insulation. In this embodiment of the invention, cap 200 includes cap hood 204, a hollow sleeve which, when cap 200 is installed, covers locking engagement area 103 of sleeve 100 as well as all of the components of the invention that are assembled around locking engagement area 103.

Referring now to FIG. 6A, what is shown is a side view of an alternate embodiment of cap 200 of the invention, where cap 200 also includes cap hood 204. In this view of cap 200, it can be seen that cap hood 204 is a hollow sleeve that extends away from the main body of cap 200 from the longitudinal end of cap 200 that is opposite the end where tapered compression bore section 203 is located. In this embodiment of cap 200, cap hood 204 has substantially the same outside diameter as the main body of cap 200. It can be seen, however, that cap hood 200 can have a smaller or larger outside diameter than that of the main body of cap 200 without straying from the features, functions and advantages claimed herein. It can also be seen that cap hood 200 can have a smaller or larger longitudinal length for accommodating various lengths of locking engagement area 103 of sleeve 100 without straying from the features, functions and advantages claimed herein.

Referring now to FIG. 6B, what is shown is an end view of cap 200 according to an alternate embodiment of the invention, where cap 200 also includes cap hood 204, shown with tapered compression bore section 203 placed away from the viewer in relation to cap hood 204. From this view it can be seen that cap hood 204, cap 200, cap teeth 201 and tapered compression bore section 203 all encircle cap bore 202. It can also be seen that cap hood 204 is a hollow sleeve that extends away from the main body of cap 200 (toward the viewer).

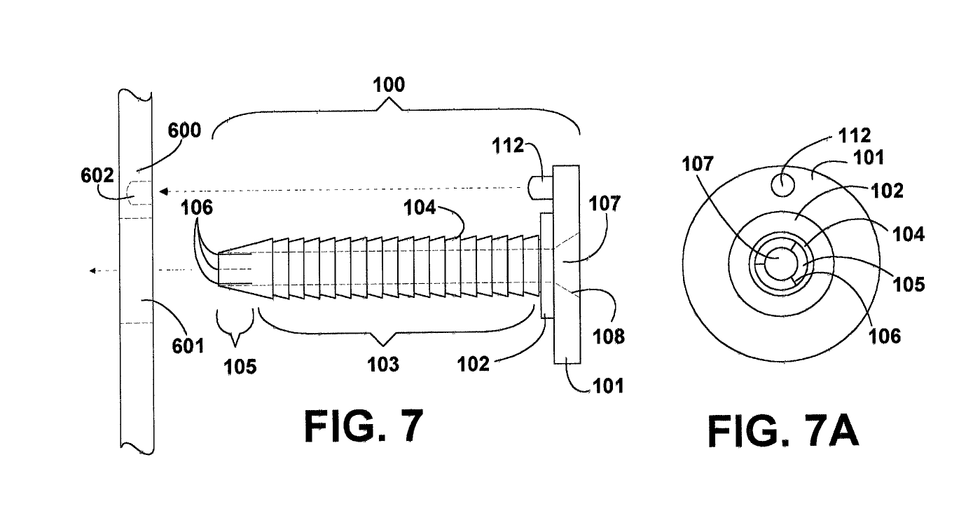

Referring now to FIG. 7, a side view is shown of an alternate embodiment of sleeve 100 of the invention, lined up for insertion through planar surface opening 601 of planar surface 600. In this embodiment of the invention, restraining flange 101 also includes restraining flange locking protuberance 112, and planar surface 600 also includes planar surface locking opening 602 positioned and dimensioned for receiving restraining flange locking protuberance 112 when sleeve 100 is inserted through planar surface opening 601 sufficiently to cause restraining flange 101 to rest directly against planar surface 600.

Referring once again to FIG. 7, it can be seen that, once installed, restraining flange locking protuberance 112 mates with, and inserts into, planar surface locking opening 602, providing additional resistance to rotation of restraining flange 101 around the longitudinal axis of sleeve bore 107.

Referring now to FIG. 7A, an end view is shown of an alternate embodiment of sleeve 100 of the invention, shown with restraining flange 101 positioned away from the viewer in relation to slots 106. In this embodiment of the invention, restraining flange 101 also includes restraining flange locking protuberance 112, positioned and dimensioned to mate with a receiving hole or indentation in an obstacle into which the feedthrough of this invention is installed. It can be seen in FIG. 7A that restraining flange 101, locating flange 102, sleeve teeth 104, and tapered clamping tabs 105 all surround sleeve bore 107. It can also be seen that slots 106 separate the individual tapered clamping tabs 105.

Variations of Specific Elements

The present invention is not limited in scope to a single specific form, but instead can find embodiment in a variety of materials, specific shapes, sizes, colors and elemental specifics while still providing the functions, features and benefits claimed herein.

For instance, the shape of the restraining flange 101 may be circular, square, hexagonal or rectangular in shape without eliminating from the article the functions, features and benefits claimed herein. In fact, this allows the advantage of producing the invention in forms that are most appropriate for certain specific applications. If, for example, a need arises for a narrower, shortened version of the invention, production of a narrower, shorter locking engagement area 103 of sleeve 100 of the invention would provide a product that meets this need without falling outside the scope of the functions, features and benefits claimed herein.

The following variations to elements of the present invention are examples of embodiments of the article that fall within the scope of what is claimed herein. The number, size and shape of tapered clamping tabs 105 and slots 106 (used to allow clamping the feedthrough assembly onto an object passing through sleeve 100 of the invention) may be varied to maximize clamping strength and reliability. The first ferrite bead 501 and second ferrite bead 502 may be mounted in separated positions on the sleeve using additional locking rings 300 or by placing compressible disk 400 between first ferrite bead 501 and second ferrite bead 502. Additionally, the exact angle of taper and depth to which tapered exit hole 108 is recessed into restraining flange 101 of sleeve 100 can be varied without causing the article to fall outside the scope of the benefits, features and functions claimed herein. Clearly, larger or smaller scale versions of each embodiment of the invention can be made to accommodate various installation requirements while still providing the features, functions and advantages claimed herein.

It can therefore be seen that the present invention provides the all of the functions, features and advantages claimed herein.

The specifics detailed in this disclosure should not be construed to be the limits of this invention, but rather illustrious of the current preferred embodiment and a selection of some of the possible alternate embodiments. The scope of the invention should be determined by the appended claims and their legal equivalents, rather than solely by the examples given. It will be clear to anyone reasonably skilled in the art that many possible variations in the colors, scale, exact shape and relative proportions of the present invention's component parts and elements are possible without substantively changing the functions, features and advantages claimed herein

We claim:

1. An insulating, securing, clamping feedthrough comprising: a hollow sleeve with a transverse restraining flange at one end of said hollow sleeve's longitudinal axis, said hollow sleeve having a sleeve bore extending the entire length of the longitudinal axis of said hollow sleeve, said hollow sleeve also having a clamping section connected to the end of said hollow sleeve's longitudinal axis that is opposite the end where said transverse restraining flange is located, said clamping section comprising at least one bendable protuberance attached to and extending away from said hollow sleeve, said bendable protuberance being dimensioned appropriately to make contact with a passthrough object if said pass-through object is already inserted at least partially into said sleeve bore of said hollow sleeve when said bendable protuberance is forced to bend sufficiently inward toward the longitudinal axis of said hollow sleeve, said hollow sleeve having also a sleeve engagement area defining at least a portion of the external surface of said hollow sleeve that is contained between said transverse restraining flange and said clamping section said sleeve engagement area having at least one sleeve locking irregularity on the surface of said sleeve engagement area, said transverse restraining flange extending sufficiently away from the center of said hollow sleeve to have at least a portion of said transverse restraining flange extending outward beyond the widest external diameter of said hollow sleeve, said transverse restraining flange also having a transverse restraining flange bore coaxially aligned with, and substantially the same diameter as, said sleeve bore of said hollow sleeve, said hollow sleeve having a sleeve bore of sufficient diameter to accommodate at least the largest outside dimension of said pass-through object that is intended to be passed through at least a portion of said hollow sleeve; a compressor cap for engaging with said sleeve engagement area of said hollow sleeve and causing the clamping action of said clamping section, at least a portion of said compressor cap pressing tightly against any object that is located between said compressor cap and said transverse restraining flange of said hollow sleeve when said compressor cap is sufficiently engaged with said sleeve engagement area of said hollow sleeve, said compressor cap having a cap bore that traverses an entire axis of said compressor cap, said cap bore having a diameter no greater than that sufficient to allow said cap bore to slide over said sleeve locking irregularity on the surface of said sleeve engagement area of said hollow sleeve, said compressor cap having an outside dimension sufficiently large to surround said cap bore, a narrowed section of said cap bore having a sufficiently small diameter to force inward deflection of said bendable protuberance toward the longitudinal axis of said sleeve bore when said compressor cap is slid far enough onto said hollow sleeve to cause said narrowed section of said compressor cap to slide over the outside of said bendable protuberance, said cap bore of said compressor cap also having a cap engagement area defining at least a portion of the inside surface of said cap bore of said compressor cap, said cap engagement area of said compressor cap having at least one cap locking irregularity on the surface of said cap engagement area for engaging with said sleeve locking irregularity, said cap locking irregularity of said compressor cap engaging with said sleeve locking irregularity of said sleeve engagement area in such a manner as to provide sufficient resistance against motion of said compressor cap in the direction away from said transverse restraining flange once said compressor cap is installed sufficiently over said clamping section and said sleeve engagement area of said hollow sleeve.

2. The invention of claim 1, also including an adhesive coating on at least a portion of the surface of said transverse restraining flange that faces said sleeve engagement area of said hollow sleeve, said adhesive coating at least temporarily securing said transverse restraining flange against an exterior surface of an obstacle through which at least a portion of said sleeve engagement area of said hollow sleeve has passed.

3. The invention of claim 1, said transverse restraining flange also including at least one flange edge hole, each said flange edge hole comprising an opening entirely traversing an axis of said transverse restraining flange, each said flange edge hole not being contained entirely within said transverse restraining flange bore, each said flange edge hole having a set of external dimensions that allow said flange edge hole to accommodate engagement with an external hooking, gripping, tying or similar attaching mechanism.

4. The invention of claim 1, also including a compressible ring that slides onto said sleeve engagement area of said hollow sleeve, said compressible ring, when compressed between said compressor cap and said transverse restraining flange, providing additional back-pressure against said compressor cap causing said cap locking irregularity on the surface of said cap engagement area to transfer said back-pressure to said sleeve locking irregularity, thereby pulling said transverse restraining flange toward said compressor cap, thus strongly securing between said compressor cap and said transverse restraining flange any objects or obstacles through which said sleeve engagement area passes.

5. The invention of claim 1, also including at least one ferromagnetic toroid surrounding at least a portion of said hollow sleeve, each said ferromagnetic toroid being located between said compressor cap and said transverse restraining flange, any such ferromagnetic toroid being secured into position along with any other object surrounding said hollow sleeve by being trapped between said compressor cap and said transverse restraining flange when said compressor cap is slid at least partially over said sleeve engagement area of said hollow sleeve toward said transverse restraining flange, each said ferromagnetic toroid providing electromagnetic filtering action on any conductive materials that pass through the center of said ferromagnetic toroid according to the dimensions and specific composition of said ferromagnetic toroid.

6. The invention of claim 1, wherein said hollow sleeve also includes a locating flange positioned between said transverse restraining flange and said sleeve engagement area, at least a portion of said locating flange being directly adjacent to the surface of said transverse restraining flange that faces said clamping section, said locating flange being connected to and extending generally away from the main body of said hollow sleeve, said locating flange extending also along the longitudinal axis of said hollow sleeve generally away from said transverse restraining flange, said locating flange being appropriately dimensioned to substantially mate with and insert at least partially into a surface guidance opening or depression in a surface of an obstacle, said surface guidance opening or depression being directly adjacent to an opening in said obstacle through which said sleeve engagement area passes when said transverse restraining flange rests against said surface of said obstacle.

7. The invention of claim 1 also including a locking protuberance connected to and extending generally away from the surface of said transverse restraining flange that faces said clamping section, said locking protuberance being dimensioned to fit substantially into an appropriately positioned and dimensioned mating locking hole or indentation in an obstacle surface, said mating locking hole or indentation being located in said obstacle surface at substantially the same distance from a feedthrough opening in said obstacle through which said sleeve engagement area passes as is said locking protuberance when said transverse restraining flange is in its installed position resting at least partially against said object surface.

8. The invention of claim 1 wherein at least a portion of said transverse restraining flange bore of said transverse restraining flange is tapered from the diameter of said sleeve bore to a wider diameter, said transverse restraining flange bore having its narrowest diameter where said transverse restraining flange bore meets said sleeve bore, said transverse restraining flange bore having its widest diameter where said transverse restraining flange bore exits the exterior surface of said transverse restraining flange, providing a tapered bore exit to prevent damage to said pass-through object where said pass-through object exits said transverse restraining flange bore.

9. The invention of claim 1, including also an irregular surface texture on at least a portion of the surface of said bendable protuberance that makes contact with said pass-through object when clamping action of said bendable protuberance occurs, said irregular surface texture providing improved gripping of said pass-through object during clamping action of said bendable protuberance against said pass-through object, all unconnected outside surfaces of said bendable protuberance having a texture and shape that prevents said unconnected outside surfaces of said bendable protuberance from cutting, chafing or otherwise damaging said pass-through object when said pass-through object makes contact with any portion of said bendable protuberance.

10. The invention of claim 1 wherein said sleeve engagement area is longitudinally lengthened at least sufficiently to allow a locking ring to surround said sleeve engagement area between said clamping section and said transverse restraining flange, said locking ring having a locking ring bore that traverses an entire axis of said locking ring, said locking ring bore having a diameter no greater than that sufficient to allow said locking ring to slide over said sleeve locking irregularity on the surface of said sleeve engagement area of said hollow sleeve, said locking ring having an outside dimension sufficiently large to surround said locking ring bore, said locking ring also having a locking ring engagement area defining at least a portion of the inside surface of said locking ring, said locking ring engagement area of said locking ring having at least one locking ring locking irregularity on the surface of said locking ring engagement area for engaging with said sleeve locking irregularity, said locking ring locking irregularity of said locking ring engaging with said sleeve locking irregularity of said sleeve engagement area in such a manner as to provide sufficient resistance against motion of said locking ring in the direction away from said transverse restraining flange once said locking ring is installed sufficiently over said sleeve engagement area of said hollow sleeve;
said compressor cap not necessarily making contact with any object that is located between said compressor cap and said transverse restraining flange of said hollow sleeve when said compressor cap is sufficiently engaged with said sleeve engagement area of said hollow sleeve.

11. The invention of claim 1 wherein said compressor cap also includes a hollow cap extension originating from the longitudinal end of said compressor cap that is opposite where said narrowed section of said cap bore is located, said hollow cap extension being dimensioned and extending away from the main body of said compressor cap in such a manner as to at least partially encase at least one other object that surrounds said sleeve engagement area of said hollow sleeve when said compressor cap is slid at least partially over said locking engagement area of said hollow sleeve.

12. The invention of claim 10 wherein said locking ring also includes at least one locking ring compressible section, each said locking ring compressible section being located at a longitudinal end of said locking ring, said locking ring bore extending through each said locking ring compressible section, said locking ring compressible section providing additional back-pressure against said locking ring when said locking ring compressible section is compressed against another object that surrounds at least a portion of said hollow sleeve or when said locking ring compressible section is compressed against said transverse restraining flange.

13. The invention of claim 1 wherein said compressor cap also includes a cap compressible section, said cap compressible section being located at the longitudinal end of said compressor cap that is opposite where said narrowed section of said cap bore is located, said cap bore extending through said cap compressible section, said cap compressible section providing additional back-pressure against said compressor cap when said cap compressible section is compressed against another object that surrounds at least a portion of said hollow sleeve or when said cap compressible section is compressed against said transverse restraining flange.

14. The invention of claim 1 wherein said transverse restraining flange also includes a transverse restraining flange compressible section, said transverse restraining flange compressible section being located on the side of said transverse restraining flange that faces said clamping section, said transverse restraining flange bore extending through said transverse restraining flange compressible section, said transverse restraining flange compressible section providing additional back-pressure against an object when said transverse restraining flange compressible section is compressed against that object.

15. The invention of claim 10 wherein at least a portion of said locking ring is constructed to contain at least some ferromagnetic material, said locking ring providing electromagnetic filtering action on any conductive materials that pass through the center of said locking ring according to the overall dimensions and specific composition of said locking ring.

16. The invention of claim 1 wherein at least a portion of said compression cap is constructed to contain at least some ferromagnetic material, said compression cap providing electromagnetic filtering action on any conductive materials that pass through the center of said compression cap according to the overall dimensions and specific composition of said compression cap.
